(19) United States
(12) Patent Application Publication
(10) Pub. No.: US 2012/0235327 A1
(43) Pub. Date: Sep. 20, 2012

(54) RECYCLED RESIN AND MANUFACTURING PROCESS THEREOF

(75) Inventors: Yasuo KURACHI, Tokyo (JP); Akira OHIRA, Tokyo (JP); Ryuji KITANI, Tokyo (JP); Yasuharu SAITA, Tokyo (JP); Masashi MAMINO, Tokyo (JP)

(73) Assignee: KONICA MINOLTA BUSINESS TECHNOLOGIES, INC., Tokyo (JP)

(21) Appl. No.: 13/411,818

(22) Filed: Mar. 5, 2012

(30) Foreign Application Priority Data
Mar. 17, 2011 (JP) 2011-058647

(51) Int. Cl. B29B 17/02; B29C 31/00

(52) U.S. Cl. 264/405; 264/37.1

(57) ABSTRACT

Disclosed are a recycled resin manufacturing process and a recycled resin, the process comprising the steps of sorting a molded waste resin product, pulverizing the sorted molded waste resin product into resin flakes, washing the resin flakes, separating the washed resin flakes to remove different kinds of resins, drying the separated resin flakes, classifying the dried resin flakes to remove foreign matter deposited on the flakes, the classifying being carried out employing a classifying apparatus comprising a classifying section and provided therein, a physical field application device having an airflow force field and another physical field other than the airflow force field, and pelletizing the classified resin flakes, wherein the recycled resin has an oligomer content of not more than 1% by mass.

This application is based on Japanese Patent Application No. 2011-058647, filed on Mar. 17, 2011 in Japanese Patent Office, the entire content of which is hereby incorporated by reference.

### FIELD OF THE INVENTION

The present invention relates to a recycled resin manufactured from a molded waste resin product and to a manufacturing process of a recycled resin.

### TECHNICAL BACKGROUND

In recent years, with enforcement of Law for the Promotion of Utilisation of Recyclable Resources (Apr. 27, 2006), public concern about environmental issues is growing in order to create a recycling society, and recovery and recycling of waste resins has been actively conducted.

Recycling of waste resins are divided into material recycling (reuse as a material) and thermal recycling (reuse as heat). Resins, which are excellent in mechanical strength and light, are widely used in interior or exterior materials, packaging materials or vessels for home electric appliances, office automation equipments, communication equipments and the like. Material recycling of resin products has been actively carried out under circumstances that conversion from the conventional economic system of mass production and mass disposal to a recycling-oriented economic system is required.

However, in the material recycling, resins used as the product (used resins), which are contaminated with different kinds of resins or have contaminants or foreign materials deposited on the surface, cannot be reused in the same applications as a virgin resin. Accordingly, it is necessary that the used resins be sorted to obtain a resin composed of the same kind of material and contaminants or foreign materials deposited on the surface thereof be removed.

A general process for recycling a waste resin in the material recycling comprises the steps of (a) sorting the waste resin to obtain a resin of single material, (b) pulverizing the sorted resin into resin flakes with a proper size, (c) washing the resin flakes to remove contaminants, (d) separation removing foreign matter incorporated from the washed resin flakes, (e) drying the resin flakes from which the foreign matter was removed, (f) classifying the dried resin flakes into a certain size, extrusion-processing the resulting flakes in an extruder to obtain pellets and (g) molding the pellets with a molding machine to obtain a mold in the optional form. In the pulverizing step above, foreign matter in the form of film, foam or powder is often incorporated in the pulverized resins. It is well known that pellets which are obtained by pelletizing the pulverized resin incorporating foreign matter greatly lower the performances as a recycled resin.

The foreign matter in the form of film, foam or powder is light as compared with the pulverized resins. A method is known which employs airflow force, static electricity or ion wind in order to selectively remove the light foreign matter. Hitherto, study has been made on a recycled resin manufacturing method which minimizes deterioration of physical properties of a resin from which the foreign matter in the form of film, foam or powder has been removed.

For example, a resin recycling system is known which comprises a pulverizing device for pulverizing reusable resins in molded resin products obtained from waste equipments according to type of molded resin products to be recycled, a sorting device for sorting the pulverized resin according to the resin kind determined based on the reflected light from the pulverized resin irradiated with light and a washing device for washing each of the sorted pulverized resins to remove foreign matter therefrom, and a recovery device for recovering the washed pulverizing resin (see, for example, Japanese Patent O.P.I. Publication No. 2002-144338).

A material recycling system is known which comprises the steps of pulverizing and volume-reducing sorted plastic resins, dry-washing the pulverized resin to remove foreign matter on the surface thereof so that the foreign matter is reduced to an amount enabling the reuse of the resin, and recovering the washed pulverized resin (see, for example, Japanese Patent O.P.I. Publication No. 2003-011124).

A method is known which comprises the step of pulverizing a waste plastic material in a specific liquid, and dissolving in the liquid contaminants, sand, water stains, oily components, wasted food, undesired additives, surface coatings and age deteriorated resin components adhered to the waste plastic material, thereby separating and removing the contaminants, sand, water stains, oily components, wasted food, undesired additives, surface coatings and age deteriorated resin components from the plastic material (see, for example, Japanese Patent O.P.I. Publication No. 2004-042461).

A resin recycling system removing a heavy material, a light material and dust from pulverized resin is known, which comprises a first step of removing the heavy material, a second step of removing the light material, and a third step of removing the dust, each step employing an airflow force (see, for example, Japanese Patent O.P.I. Publication No. 2006-326463).

When a recycled resin is manufactured according to the resin recycling system disclosed in the above-described patent Documents, it has been proved that the recycled resin obtained does not provide stable physical properties and is inferior in physical properties to waste resin products collected. It has been found that these phenomena markedly occur in the polyester based resins.

In view of the above, development of a recycled resin and a manufacturing process thereof is desired, the recycled resin minimizing a foreign matter from being incorporated therein from a waste resin during the manufacture, minimizing deterioration of physical properties of the recycled resin due to the incorporation of the foreign matter and having a physical property approximate to that of the waste resin

### SUMMARY OF THE INVENTION

The present invention has been made in view of the above. An object of the invention is to provide a recycled resin which minimizes a foreign matter from being incorporated therein from a waste resin during the manufacture and minimizes deterioration of its physical properties due to the incorporation of the foreign matter and a manufacturing process of the recycled resin.

The manufacturing process of a recycled resin of the invention comprises the steps of sorting a molded waste resin product, pulverizing the sorted molded waste resin product into resin flakes, washing the resin flakes, separating the washed resin flakes to remove different kinds of resins, drying the separated resin flakes, classifying the dried resin flakes to remove foreign matter deposited on the flakes, and pelletizing the classified resin flakes, wherein the classifying is carried out employing a classifying apparatus comprising a classifying section and provided therein, a physical field application device having an airflow force field and another physical field other than the airflow force field, and wherein the recycled resin has an oligomer content of not more than 1% by mass.

### BRIEF DESCRIPTION OF THE DRAWINGS

FIG. 1 is a schematic flow diagram of one embodiment of a manufacturing process of a recycled resin from a waste thermoplastic resin product.

FIGS. 2a and 2b are schematic views of a classifying apparatus employed in the classifying step of FIG. 1.

FIG. 3 is an enlarged schematic view of a section as shown in T in FIG. 2b of a physical field application device.

FIG. 4a or 4b is an enlarged schematic view of a section as shown in T in FIG. 2b of another physical field application device.

### DETAILED DESCRIPTION OF THE INVENTION

The above object of the invention can be attained by any one of the following constitutions:

1. A recycled resin which is reproduced by a process comprising the steps of sorting a molded waste resin product, and pulverizing the sorted resin product to resin flakes, followed by washing, separating, drying, classifying and pelletizing, wherein an oligomer content of the recycled resin is not more than 1% by mass.

2. The recycled resin of item 1 above, wherein the recycled resin comprises a polyester based resin.

3. A manufacturing process of a recycled resin, the process comprising the steps of:

sorting a molded waste resin product;

pulverizing the sorted molded waste resin product into resin flakes;

washing the resin flakes,

separating the washed resin flakes to remove different kinds of resins;

drying the separated resin flakes;

classifying the dried resin flakes to remove foreign matter deposited on the flakes, the classifying being carried out employing a classifying apparatus comprising a classifying section and provided therein, a physical field application device having an airflow force field and another physical field other than the airflow force field; and

pelletizing the classified resin flakes,

wherein the recycled resin has an oligomer content of not more than 1% by mass.

4. The manufacturing process of the recycled resin of item 3 above, the classifying section having an upper space and a lower space with a height of from 10 to 50% of a height of the classifying section, wherein the physical field application device is provided in the upper space of the classifying section.

5. The manufacturing process of the recycled resin of item 3 or 4 above, wherein the another physical field comprises a magnetic field and the physical field application device has therein a magnetic field application member for applying the magnetic field.

6. The manufacturing process of the recycled resin of item 3 or 4 above, wherein the another physical field comprises an electric field and the physical field application device has therein an electric field application member for applying the electric field.

7. The manufacturing process of the recycled resin of item 3 or 4 above, wherein the another physical field comprises a force field and the physical field application device has therein a force field application member for applying the force field.

8. The manufacturing process of the recycled resin of item 7 above, the force field application member being composed of a first shielding plate and a second shield plate, the dried resin flakes firstly colliding with the first shielding plate and then colliding with the second shielding plate, wherein when the number of the first shielding plate is n, the number of the first shielding plate is n+k, in which n and k independently represent an integer of 1 or more.

9. The manufacturing process of the recycled resin of item 3 or 4 above, wherein the molded waste resin product is composed of a polyester based resin.

10. The manufacturing process of the recycled resin of item 3 or 4 above, wherein the resin flakes after classified have a moisture content of 1% by mass.

11. The manufacturing process of the recycled resin of item 3 or 4 above, wherein the oligomer has a number average molecular weight of from 100 to 1500.

12. The manufacturing process of the recycled resin of item 3 or 4 above, wherein the pulverized resin flakes have a size of from 5 to 30 mm.

13. The manufacturing process of the recycled resin of item 12 above, wherein the pulverized resin flakes have an aspect ratio of from 1 to 10.

The present inventors have made a study on the reason that physical properties of a recycled resin deteriorate without being stabilized. As a result, it has been found that the reason is as follows.

1. Immediately before washed, dried and pelletized, resin flakes, into which waste resins have been pulverized, have a foreign matter in the gel form adherent to the surface thereof.

2. A recycled resin was analyzed, and as a result, it has proved that an oligomer content of the recycled resin is higher than that of a waste resin from which the recycled resin was obtained.

3. Particularly, a polyester based resin markedly exhibits the phenomenon as described above.

The foreign matter in the gel form adherent to the surface of the resin flakes was analyzed. As a result, it has proved that the foreign matter is one in which a fine powder produced during pulverizing of the waste resin absorbs moisture and gels, and an oligomer also exists on the flake surface.

Further, the present inventors have made a study on the reason that a foreign matter in the gel form is adherent to the flake surface or an oligomer exists on the flake surface. As a result, it has been assumed that the reason is as follows.

1. While waste resins are pulverized into resin flakes, waste resin fine powders are produced. Although most of the waste resin fine powders are removed during washing of the resin flakes, fine powders adherent to the interface between the resin flakes superimposed on one another remain without being removed. The fine powders remaining on the resin flakes absorb moisture and swell to form a gel, which shows that the fine powders are physically adsorbed onto the resin flake surface.

2. Although moisture adherent to the flakes are removed during drying of the resin flakes, the moisture in the gel adherent to the flake surface remains without being completely removed. The gel, when heated at drying, is hydrolyzed and degraded to produce an oligomer. When the resin flakes to be classified, after dried, are classified by airflow force, the resin flakes are separated into light ones and heavy ones by gravity while stirring with the airflow force. However, in this classification, only two forces, i.e., a force in an airflow direction and a force in the gravity direction are applied to the resin flakes, and therefore, the frequency of collisions between the resin flakes is reduced. Accordingly, the resin flakes, in which the gel adherent to the resin flake surface is not completely removed, are subjected to classification, resulting in classified resin flakes with the gel for a recycled resin.

3. When the classified resin flakes with the gel are melted for pelletizing and pelletized through a single-screw extruder or a twin-screw extruder, a part of the melted resin flakes is hydrolyzed by heat and the moisture contained in the gel to produce an oligomer.

4. The content of an oligomer in a recycled resin has a relationship with physical properties of the recycled resin, and a recycled resin having a high oligomer content lowers the physical properties. That is, it has been proved that the physical properties of a recycled resin vary by the content of an oligomer in a recycled resin.

In order to obtain a recycled resin with a low oligomer content and with stabilized physical properties, it is necessary that the gel adherent to the resin flakes be minimized before the resin flakes are pelletized. It has been proved that in order to remove the gel adherent to the resin flakes in the classifying step, a method in which a physical field as a force in a three-dimensional direction is applied to the resin flakes in addition to the two forces in the two-dimensional direction, i.e., a force in the airflow direction and a force in the gravity direction, can raise the frequency of collisions between the resin flakes. The present inventors have found that this method is proved to be effective in removing the gel foreign matter adherent to the resin flakes, and have completed the invention.

The present invention can provide a recycled resin which minimizes a foreign matter from being incorporated therein from a waste resin during the manufacture and minimizes deterioration of its physical properties due to the incorporation of the foreign matter and a manufacturing process of the recycled resin.

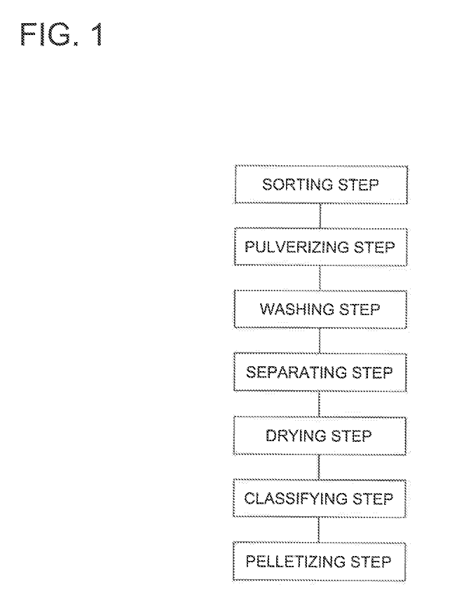

The present invention will be explained referring to FIGS. 1, 2a, 2b, 3, 4a and 4b, but the present invention is not specifically limited thereto.

FIG. 1 is a schematic flow diagram of one embodiment of a manufacturing process of a recycled resin from a waste resin product.

Manufacture of a recycled resin from a waste resin is ordinarily carried out according to a process comprising a sorting step, a pulverizing step, a washing step, a separating step, a drying step, a classifying step and a pelletizing step In the sorting step, many kinds of waste resins collected are sorted into a resin composed of the same kind of material.

In the pulverizing step, the sorted waste resin is pulverized into resin flakes (hereinafter also referred to simply as flakes) with a certain size. During the pulverization, waste resin fine powders are produced, and are deposited on the flakes or coexist in the flakes. The size of the flakes is preferably from 5 mm (a standard deviation of 0.5) to 30 mm (a standard deviation of 0.5), in view of washing property, separating property, drying property, classifying property and palletizing property. In the invention, the size of the flakes means an average value of the maximum width of the flakes defined as follows and is measured according to the following method.

### Measurement of Size of Flakes

An A size paper is prepared in which a circle with a radius of 5 cm is drawn in the center. Two grams of the flakes are placed on the center of the circle and vibrated while holding both end of the paper by hands. Thereafter, it has been visually observed that the flakes in the center of the circle do not overlap each other, and then the flake image is photographed through a single-lens reflex camera NIKON D3 equipped with AF-S, VR Micro-Nikkor 105 mm f/2.8G IF-ED, while observing the image through the D3 finder. The resulting image is printed on an A3 paper sheet, and 20 parallel lines are drawn at an interval of 1 cm on the printed image. Arbitrary 50 flake images which are on the 20 lines drawn are selected, except for the flakes overlapping each other. The maximum width and the minimum width of each of the 50 selected flake images are measured and an average and standard deviation thereof are determined. In the invention, the average maximum width of the flakes is defined as the size of the flakes, and a ratio of the average maximum width of the flakes to the average minimum width of the flakes as the aspect ratio of the flakes. In the invention, the aspect ratio of the flakes is preferably from 1 to 10, and more preferably from 1 to 5.

In the washing step, the waste resin flakes obtained above are washed to remove fine powders or foreign matter (for example, oils and fats, soil or dust) deposited on the flakes or fine powders coexisting in the flakes. The fine powders and foreign matter are almost removed by washing, but fine powders deposited at the interface between the flakes or at portions incapable of being washed of the flakes (for example, fine powders deposited at the bottom of concave parts in the flakes) remain in the flakes after washing. These remaining fine powders absorb moisture during washing, swell and gel. The fine powders in the gel state are physically adsorbed on the flakes. As resins showing such a behavior, there are mentioned a nylon resin having a polar group, a polyurethane resin and polyester based resin.

In the separating step, labels on the flakes or different kinds of resins incorporated are separated from the flakes, for example, employing the difference of the gravities.

Different kinds of resins have been removed in the above separating step, waste resin flakes composed of the same material are obtained and dried in the drying step. During the drying step, the fine powders in the gel state (hereinafter also referred to as gel substances) physically adsorbed on the flakes are hydrolyzed and degraded by heating to produce an oligomer with a lower molecular weight. A long period of time is taken in order to completely remove moisture from the gel substances, and drying may be finished in the state in which the gel substances contain moisture.

A moisture content of the flakes (containing no gel substances) after drying is preferably not more than 1% by mass, in view of thermal decomposition due to moisture during processing such as palletizing or thermal melt fibrillation. The moisture content of the gel substances is ten times or more that of the flakes.

Herein, the moisture content of the flakes refers to one measured according to a Karl Fischer's method, employing a Hiranuma trace moisture measuring device produced by Hitachi High-Technologies Corporation.

In the classifying step, removal of the waste resin fine powders incorporated in the flakes or the gel substances deposited on the flakes is carried out, employing a classifying apparatus comprising a physical field application device employing a combination of an airflow force and another physical field other than the airflow force. A moisture content of the flakes after classifying is preferably not more than 1% by mass, in view of thermal decomposition due to moisture during processing such as palletizing or thermal melt fibrillation.

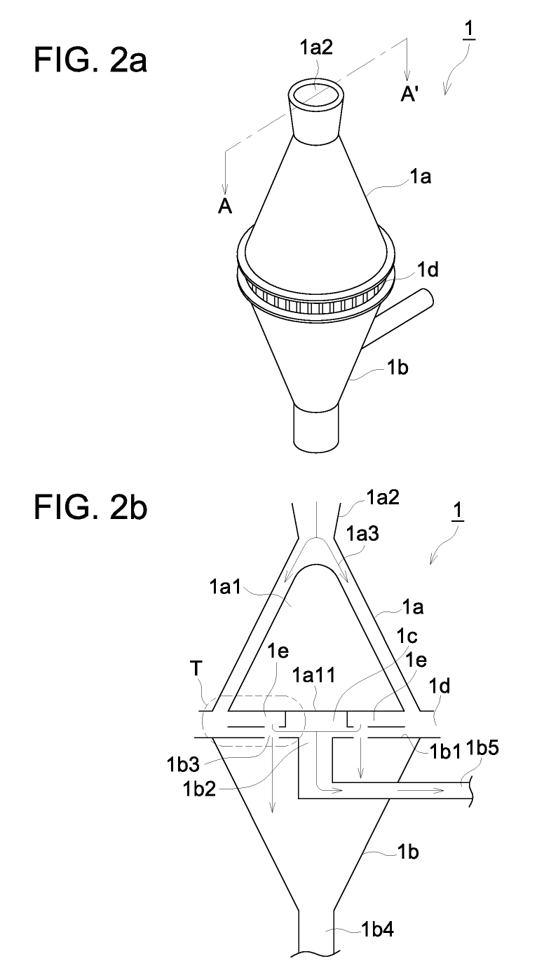

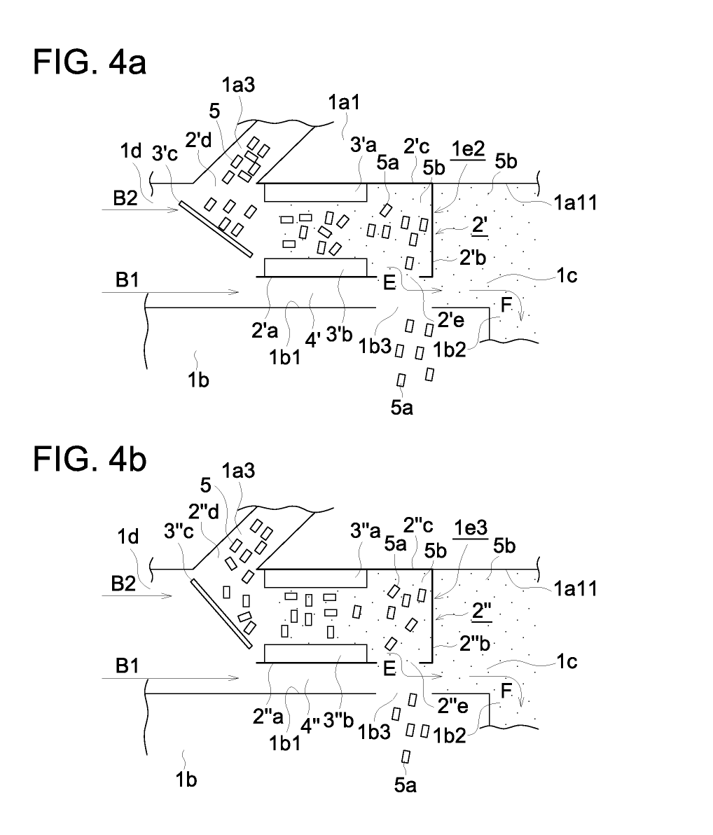

In the invention, the physical field refers to a magnetic field or an electric field each capable of giving kinetic energy to substances. In the invention, the physical field includes a magnetic field, an electric field or a force field other than an airflow force. Examples of the force field other than an airflow force include, for example, a barrier in a rotator, in which powders introduced into the rotator collide with the barrier, whereby kinetic energy is given to the powders. Further, kinetic energy may be used which is generated by collision among the fine powders forced by turbulence caused from airflow used for transporting and classifying. With respect to a classifying apparatus employing airflow force in combination with a magnetic field or an electric field, explanation will be made referring to FIGS. 2a and 2b and FIGS. 4a and 4b.

In the palletizing step, the flakes, after classifying has been finished, are pelletized through a pelletizer to obtain a recycled resin.

In the invention, the content of an oligomer contained in the recycled resin is not more than 1% by mass. When the content of an oligomer in the recycled resin exceeds 1% by mass, impact strength or tensile strength of the recycled resin deteriorates, resulting in incapability of a single application of the recycled resin, which is undesirable.

Herein, the content (% by mass) of an oligomer contained in the recycled resin is a value measured according to a quantitative method as described below.

A recycled resin sample (hereinafter also referred to as a sample) of 0.1 g is dissolved in a 2 ml of a mixture solvent of hexafluoroisopropanol and chloroform (1/1). When an undissolved component is found in the resulting solution, another sample is dissolved in the mixture solvent. This dissolving process is carried out until the sample is completely dissolved in the mixture solvent to obtain a uniform solution. Then, the resulting uniform solution is diluted with 50 ml of chloroform, further added with 100 ml of acetonitrile, and filtered to remove undissolved components produced. The resulting filtrate is introduced in a round-bottom recovery flask with a weight of A, and subjected to evaporation to remove the solvent. The weight B of the resulting round-bottom recovery flask is determined. Then, B minus A is defined as an amount of the oligomer contained in the sample of 0.1 g above. Then, the content (% by mass) of an amount of the oligomer contained in the sample is obtained by the following formula:

Content (% by mass) of an oligomer contained in the sample=(B−A)×100/0.1

In the invention, the oligomer means a low molecular weight polymeric compound having a number average molecular weight of from 100 to 1500.

In the invention, the number average molecular weight of the oligomer is measured according to gel permeation chromatography (GPC). Measurement of the molecular weight according to GPC is conducted as follows. Using an apparatus HLC-8220 (produced by TOSOH CORP.) and a column TSK guard column+TSK gel Super HZM-M3 (produced by TOSOH CORP.), THF as a carrier solvent is fed at a flow rate of 0.2 ml/min, while maintaining a column temperature of 40° C. A sample is dissolved in THF at mom temperature so as to have a concentration of 1 mg/ml, while dispersing for 5 min. by using an ultrasonic dispersing machine and then filtered by a membrane filter of a 0.2 μm pore size to obtain a sample solution. Then, 10 μl of this sample solution is injected with the carrier solvent into the GPC column and is detected by a refractive index detector (RI detector). The number average molecular weight of the sample is calculated using a calibration curve prepared by using monodisperse polystyrene standard particles.

Each step as shown in FIG. 1 may be continuous or be of a batch type in which each step is independent.

The present invention relates to a process of manufacturing a recycled resin from a waste resin employing a classifying apparatus comprising a physical field application device employing a combination of an airflow force and another physical field other than the airflow force and to a recycled resin reproduced according to the manufacturing process.

FIGS. 2a and 2b are schematic views of a classifying apparatus employed in the classifying step of FIG. 1. FIG. 2a is a perspective view of a classifying apparatus employed in the classifying step of FIG. 1. FIG. 2b is a schematic view of a cross-section of the classifying apparatus obtained when it is cut by line A-A′ in the direction of an arrow as shown in FIG. 2a

In FIGS. 2a and 2b, a numerical number 1 shows a classifying apparatus. The classifying apparatus 1 comprises an upper circular truncated cone-shaped vessel 1a and a lower circular truncated cone-shaped vessel 1b. A symbol 1c shows a circular classifying section formed between a base 1a11 of an inner vessel 1a1 and a top 1b1 of the lower vessel 1b, an air introduction port 1d being provided around the classifying section.

The upper vessel 1a comprises the inner vessel 1a1, a resin sample (resin in the form of flakes) supply port 1a2 provided on the top of the upper vessel 1a, and a resin sample (resin in the form of flakes) supply path 1a3 formed between an inner wall of the upper vessel 1a and an outer wall of the inner vessel 1a1.

The lower vessel 1b comprises a first exhaust port 1b2 at the center of the top 1b1, a second exhaust port 1b3 around the first exhaust port 1b2 and a recovery port 1b4 at the bottom. The first exhaust port 1b2 is located at the end of a suction pipe 1b5 connected with a suction pump (not illustrated).

The recovery port 1b4 is connected with a recovery case (not illustrated) and with a suction pipe (not illustrated) connected with a suction pump (not illustrated). When waste resin flakes are classified in the classifying apparatus 1, an air amount suctioned from the air suction pipe 1b5 and an air amount suctioned from the recovery port 1b4 are required to be adjusted in accordance with an amount or a size of the waste resin flakes to be classified. However, it is necessary that the suction strength from the recovery port 1b4 be lower than that from the suction pipe 1b5, in view of recovery rate of the classified flakes, removal of foreign matter from the flakes, and the like.

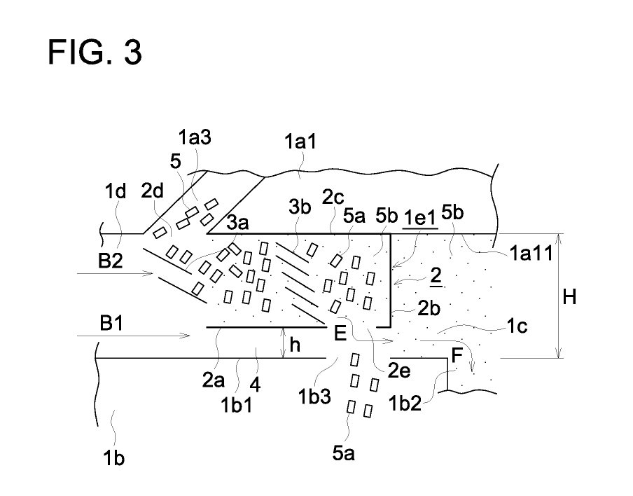

A physical field application device 1e in the form of doughnut is provided in the vicinity of the air introduction port 1d in the classifying section 1c. Mother physical field as well as airflow force is applied to a waste resin sample (resin flakes with foreign matter deposited) in the physical field application device 1e, so that foreign matter deposited on the resin flakes is removed from the resin flakes and the resin flakes with foreign matter deposited are divided into foreign matter and the resin flakes. The resulting foreign matter is discharged from the first exhaust port 1b2 together with air through the suction pipe 1b5. The resin flakes from which foreign matter has been removed is recovered from the second exhaust port 1b3 through the recovery port 1b4. As the physical filed application device 1e, there is mentioned a physical field application device capable of applying a force field, an electric field or a magnetic field other than airflow force. The physical field application device 1e will be explained referring to FIGS. 3, 4a and 4b.

FIG. 3 is an enlarged schematic view of a section as shown in T in FIG. 2b of a physical field application device.

In FIG. 3, a symbol 1e1 shows a physical field application device. The physical field application device 1e1 comprises a housing 2 and provided therein, a first shielding plate 3a and a second shielding plate 3b. A slope at which the first shielding plate 3a and the second shielding plate 3b are provided is not specifically limited as long as it is such that air introduced from the air introduction port 1d becomes turbulent. The slope of the first shielding plate 3a may be the same as or different from that of the second shielding plate 3b.

The number of the first shielding plate 3a and the second shielding plate 3b to be provided varies due to the size of the physical field application device 1e1 and is not specifically limited. When the number of the first shielding plate 3a is n, the number of the second shielding plate 3b is preferably n+k, in which n and k independently represent an integer of 1 or more.

Each of the first shielding plate 3a and the second shielding plate 3b is a disc in the doughnut form. The diameter of the disc is preferably from 10 to 80 mm in view of classification efficiency and classification accuracy.

The housing 2 has a case structure having an opening on the side of the air introduction port 1d, a bottom plate 2a, a side plate 2b and a ceiling plate 2c, and is provided in the doughnut form in the vicinity of the air introduction port 1d around the circular classifying section 1c so as to form, under the base 1a11 of the inner vessel 1a1 , a space 4 between the bottom plate 2a and the top 1b1 of the lower vessel 1b. The housing 2 has an opening 2d of the resin sample (resin in the form of flakes) supply path 1a3 in the ceiling plate 2c, and an opening 2e in the bottom plate 2a at a position facing the second exhaust port 1b3.

A height h of the space 4 (a height from the top 1b1 of the lower vessel 1b to the bottom plate 2a) is preferably from 10 to 50% of a height H from the base 1a11 of the inner vessel 1a1 to the top 1b1 of the lower vessel 1b (i.e., a height of the classifying section 1c) in view of classification efficiency and classification accuracy.

Next, a step will be explained in which foreign matter deposited on the resin flakes is removed from the resin flakes employing a classifying apparatus comprising the physical field application device 1e1 as shown in this figure.

1) A suction pump (not illustrated) being driven, air is introduced from the air introduction port 1d, and flows both in the housing 2 of the physical field application device 1e1 (in the direction of an arrow B2) and in the direction of the space 4 (in the direction of an arrow B1). The air which flows in the housing 2 (in the direction of an arrow B2) causes turbulence by the first shielding plate 3a and further colloid with the second shielding plate 3b to cause further turbulence.

2) Foreign matter deposited resin flakes 5, which are supplied from the resin sample (resin in the form of flakes) supply path 1a3, are dropped in the inside of the housing 2 from the opening 2d of the housing 2.

3) The dropped foreign matter deposited resin flakes 5 colloid with the first shielding plate 3a, whereby they are further crushed to foreign matter deposited resin flakes in the form of leaves.

4) The foreign matter deposited resin flakes 5 in the form of leaves are transported by the turbulent air and further colloid with the second shielding plate 3b. The foreign matter deposited resin flakes 5, which have been crushed to be in the form of leaves before or after they collide with the second shielding plate 3b, repeatedly colloid with one another. During the repeated collision, the foreign matter 5b is separated from the foreign matter deposited resin flakes 5 so that the foreign matter 5b and resin flakes 5a separately exist in the housing 2. That is, the foreign matter deposited resin flakes 5 are subjected to a force field generated by the collision as well as to force due to air flow and gravity, so that the foreign matter 5b is separated from the foreign matter deposited resin flakes 5.

5) Air introduced in the housing 2, after it colloids with the second shielding plate 3b, flows in the classifying section 1c direction (in the direction of an arrow E) through the opening 2e. At this time the resin flakes 5a and the foreign matter 5b are fed simultaneously to the classifying section 1c.

6) The resin flakes 5a and the foreign matter 5b fed to the classifying section 1c are carried by air flowing in the space 4 (the flowing speed of air flowing in the space 4 is higher than that of air flowing out of the opening 2e), wherein the light foreign matter 5b is fed in the first exhaust port 1b2 (in the direction of an arrow F) and discharged through the suction pipe 1b5 (refer to FIG. 2b), and the resin flakes 5a drop from the second exhaust port 1b3 to the lower vessel 1b due to gravity to be recovered through the recovery port 1b4 (refer to FIG. 2b).

The resin flakes 5a recovered are pelletized in the successive palletizing step and used as a recycled resin.

Classification Conditions in the Physical Field Application Device as Shown in this Figure

The supply amount of the foreign matter deposited resin flakes (hereinafter also referred to simply as the resin flake supply amount or flake supply amount) to the physical field application device is preferably from 1 to 500 kg/hour under condition such that no foreign matter in the gel state is visually observed, taking classification efficiency into consideration.

The amount of air suctioned from the suction pipe 1b5 (refer to FIG. 2b) and that suctioned from the recovery port 1b4 (refer to FIG. 2b), although not specifically limited, are suitably adjusted according to the size of the resin flakes, the resin flake supply amount, classification efficiency or classification accuracy. For example, when the flake supply amount is 100 kg per hour, the amount of air suctioned from the suction pipe 1b5 (refer to FIG. 2b) is preferably from 10 to 20 m³/minute in view of classification efficiency or classification accuracy, and the amount of air suctioned from the recovery port 1b4 (refer to FIG. 2b) is preferably from 10 to 20 m³/minute in view of classification efficiency or classification accuracy. The amount of air flowing in the housing 2 (in the direction of an arrow B2) from the air introduction port 1d (the amount of air exhausted from the opening 2e) is preferably from 10 to 20 m³/minute, and the amount of air flowing in the direction of the space 4 (in the direction of an arrow B1) is preferably from 1 to 10 m³/minute.

The amount of suction air is represented by a value obtained by multiplying air velocity by the cross-section area of a pipe in which air flows. The airflow velocity is a value measured through an Anemomaster Air Velocity Meter Model 6141 produced by Nippon Kanomax Co., Ltd.

The temperature is preferably from 0 to 60° C. in view of impact strength on collision of the resin flakes, separation of foreign matter in the gel state and the like. The temperature is one measured through a bar temperature sensor produced by Keyence Co., Ltd.

The strength of the force field generated is not specifically limited, since it is not determined only by air velocity or air amount and also depends on the size of the resin flakes. For example, when the size of the flakes is 1 mm (a standard deviation of 0.3), the strength is preferably from 0.1 to 10N.

A force field to be applied is represented by an average of the measurements obtained by measuring for 2 minutes forces which are generated when resin flakes colloid with a square plate with a size of 5 mm×5 mm placed at the tip of a Linear Gauge produced by Ono Sokki Co., Ltd.

FIG. 4a or 4b is an enlarged schematic view of a section as shown in Tin FIG. 2b of another physical field application device. FIG. 4a is an enlarged schematic view of a section as shown in Tin FIG. 2b of a physical field application device for applying electric field to a resin sample (resin flakes), and FIG. 4b is an enlarged schematic view of a section as shown in Tin FIG. 2b of a physical field application device for applying magnetic field to a resin sample (resin flakes).

Next, the physical field application device as shown in FIG. 4a will be explained.

In FIG. 4a, a symbol 1e2 shows a physical field application device. The physical field application device 1e2 comprises a housing 2′ and provided therein, an anode 3′a, a cathode 3′b and a charging plate 3′c. As the charging plate 3′c, there is mentioned a plate of polyester, nylon or polyurethane.

The cathode 3′b is provided to be opposed to the anode 3′a, and the anode 3′a and the cathode 3′b may be reversely provided.

The housing 2′ has a case structure having an opening on the side of the air introduction port 1d, a bottom plate 2′a, a side plate 2′b and a ceiling plate 2′c and is provided in the doughnut form in the vicinity of the air introduction port 1d around the circular classifying section 1c so as to form, under the base 1a11 of the inner vessel 1a1, a space 4′ between the bottom plate 2′a and the top 1b1 of the lower vessel 1b. The housing 2′ has an opening 2′d of the resin sample (resin in the form of flakes) supply path 1a3 in the ceiling plate 2′c, and an opening 2′e in the bottom plate 2′a at a position facing the second exhaust port 1b3.

A height of the space 4′ (a height from the top 1b1 of the lower vessel 1b to the bottom plate 2′a of the housing 2′) is preferably from 10 to 50% of a height from the base 1a11 of the inner vessel 1a1 to the top 1b1 of the lower vessel 1b (a height of the classifying section 1c) in view of classification efficiency and classification accuracy.

Next, a step will be explained in which foreign matter deposited on the resin flakes is removed from the resin flakes employing a classifying apparatus comprising the physical field application device 1e2 as shown in this figure.

1) A suction pump (not illustrated) being driven, air is introduced from the air introduction port 1d, and flows both in the housing 2′ of the physical field application device 1e2 (in the direction of an arrow B2) and in the direction of the space 4′ (in the direction of an arrow B1).

2) Foreign matter deposited resin flakes 5, which are supplied from the resin sample (resin in the form of flakes) supply path 1a3, are dropped in the inside of the housing 2′ from the opening 2′d of the housing 2′.

3) The dropped foreign matter deposited resin flakes 5 colloid with the charging plate 3′c to be charged.

4) The charged foreign matter deposited resin flakes 5 are carried between the anode 3′a and the cathode 3′b by air flowing from the air introduction port 1d. Voltage being applied across the anode 3′a and the cathode 3′b, an electric field is generated between the anode 3′a and the cathode 3′b. The charged foreign matter deposited resin flakes 5 passing in this electric field are subjected to application of the electric field. Since the charged foreign matter deposited resin flakes 5 are subjected to various electric fields different due to their size, the charged foreign matter deposited resin flakes 5 are in the state of turbulence between the anode 3′a and the cathode 3′b, and repeatedly colloid with one another. During the repeated collision, the foreign matter 5b is separated from the foreign matter deposited resin flakes 5 so that the foreign matter 5b and resin flakes 5a separately exist in the housing 2′. That is, the charged foreign matter deposited resin flakes 5 are subjected to the electric field application as well as gravity and force due to air flow, so that flow of the charged foreign matter deposited resin flakes 5 is turbulent, whereby collision frequency of the foreign matter deposited resin flakes 5 is increased and the foreign matter 5b is separated from the foreign matter deposited resin flakes 5.

5) Air introduced in the housing 2′, after passing between the anode 3′a and the cathode 3′b, flows in the classifying section 1c direction (in the direction of an arrow E) through the opening 2′e. At this time the resin flakes 5a and the foreign matter 5b are fed simultaneously to the classifying section 1c.

6) The resin flakes 5a and the foreign matter 5b fed to the classifying section 1c are transported by air flowing in the space 4′ (the flowing speed of air flowing in the space 4′ is higher than that of air flowing out of the opening 2′e), wherein the light foreign matter 5b is fed in the first exhaust port 1b2 (in the direction of an arrow F) and discharged through the suction pipe 1b5 (refer to FIG. 2b), and the resin flakes 5a drop from the second exhaust port 1b3 to the lower vessel 1b due to gravity to be recovered through the recovery port 1b4 (refer to FIG. 2b).

The resin flakes 5a recovered are pelletized in the successive palletizing step and used as a recycled resin.

Classification Conditions of the Physical Field Application Device as Shown in this Figure

The flake supply amount is preferably from 1 to 500 kg/hour under condition such that no foreign matter in the gel state is visually observed, taking classification efficiency into consideration.

The amount of air suctioned from the suction pipe 1b5 (refer to FIG. 2b) and the amount of air suctioned from the recovery port 1b4 (refer to FIG. 2b), although not specifically limited, are suitably adjusted according to the resin flake supply amount. For example, when the flake supply amount is 100 kg per hour, the amount of air suctioned from the suction pipe 1b5 (refer to FIG. 2b) is preferably from 10 to 20 m³/minute in view of classification efficiency or classification accuracy, and the amount of air suctioned from the recovery port 1b4 (refer to FIG. 2b) is preferably from 10 to 20 m³/minute in view of classification efficiency or classification accuracy. The amount of air flowing in the housing 2′ (in the direction of an arrow B2) from the air introduction port 1d (an amount of air exhausted from the opening 2′e) is preferably from 10 to 20 m³/minute, and the amount of air flowing in the direction of the space 4′ (in the direction of an arrow B1) is preferably from 1 to 10 m³/minute.

The amount of suction air is represented by a value obtained by multiplying air velocity by the cross-section area of a pipe in which air flows. The airflow velocity is a value measured through an Anemomaster Air Velocity Meter Model 6141 produced by Nippon Kanomax Co., Ltd.

The temperature is preferably from 0 to 60° C. in view of impact strength on collision of the resin flakes, separation of foreign matter in the gel state and the like. The temperature is one measured through a bar temperature sensor produced by Keyence Co., Ltd.

In this classifying apparatus, the electric field to be applied is preferably from 1 V/mm to 1 kV/mm, in view of safety, classification efficiency and the like. The electric field to be applied may be an alternating current or a direct current. The applied electric field is preferably an alternating current of not more than 10 Hz from the viewpoint that the resin flakes effectively collide with one another at a lower current.

The applied electric field can be measured by means of a general tester, and is measured, for example, by means of XY-361TR produced by Sanwa Denki Keiki Co., Ltd.

Next, the physical field application device as shown in FIG. 4b will be explained.

In FIG. 4b, a symbol 1e3 shows a physical field application device. The physical field application device 1e3 comprises a housing 2″ and provided therein, a first magnet 3″a, a second magnet 3″b and a charging plate 3″c. As the charging plate 3″c, there is employed the same as the charging plate 3′c employed in the physical field application device 1e2 as shown in FIG. 4a.

The first magnet 3″a and the second magnet 3″b are provided to be opposed to each other, and it is necessary that one of them form an N pole and the other an S pole. As magnets employed, there are mentioned an electro-magnet and a permanent magnet.

The housing 2″ has a case structure having an opening on the side of the air introduction port 1d, a bottom plate 2″a, a side plate 2″b and a ceiling plate 2″c and is provided in the doughnut form in the vicinity of the air introduction port 1d around the circular classifying section 1c so as to form, under the base 1a11 of the inner vessel 1a1, a space 4″ between the bottom plate 2″a and the top 1b1 of the lower vessel 1b. The housing 2″ has an opening 2″d of the resin sample (resin in the form of flakes) supply path 1a3 in the ceiling plate 2″c, and an opening 2″e in the bottom plate 2″a at a position facing the second exhaust port 1b3. A height of the space 4″ (a height between the top 1b1 of the lower vessel 1b to the bottom plate 2″a of the housing 2″) is the same as that of the space 4′ of the physical field application device 1e2 as shown in FIG. 4a

Next, a step will be explained in which foreign matter deposited on the resin flakes is removed from the resin flakes employing a classifying apparatus comprising the physical field application device 1e3 as shown in this figure.

1) A suction pump (not illustrated) being driven, air is introduced from the air introduction port 1d, and flows in the housing 2″ of the physical field application device 1e3 (in the direction of an arrow B2) and in the direction of the space 4″ (in the direction of an arrow B1).

2) Foreign matter deposited resin flakes 5, which are supplied from the resin sample (resin in the form of flakes) supply path 1a3, are dropped in the inside of the housing 2″ from the opening 2″d of the housing 2″.

3) The dropped foreign matter deposited resin flakes 5 colloid with the charging plate 3″c to be charged.

4) The charged foreign matter deposited resin flakes 5 are transported to the magnetic field generated between the first magnet 3″a and the second magnet 3″b by air flowing from the air introduction port 1d. The charged foreign matter deposited resin flakes 5 passing in the magnetic field are subjected to application of the magnetic field. Since the charged foreign matter deposited resin flakes 5 are subjected to various magnetic fields different due to their size, the charged foreign matter deposited resin flakes 5 are in the state of turbulence between the first magnet 3″a and the second magnet 3″b, and repeatedly colloid with one another. During the repeated collision, the foreign matter 5b is separated from the foreign matter deposited resin flakes 5 so that the foreign matter 5b and resin flakes 5a separately exist in the housing 2″. That is, the charged foreign matter deposited resin flakes 5 are subjected to the magnetic field application as well as force due to air flow and gravity, so that flow of the charged foreign matter deposited resin flakes 5 is turbulent by the forces applied, whereby their collision frequency is increased and the foreign matter 5b is separated from the foreign matter deposited resin flakes 5.

5) Air introduced in the housing 2″, after passing between the first magnet 3″a and the second magnet 3″b, flows in the classifying section 1c direction (in the direction of an arrow E) through the opening 2″e. At this time the resin flakes 5a and the foreign matter 5b are fed simultaneously to the classifying section 1c.

6) The resin flakes 5a and the foreign matter 5b fed to the classifying section 1c are carried by air flowing in the space 4″ (the flowing speed of air flowing in the space 4″ is higher than that of air flowing out of the opening 2″e.), wherein the light foreign matter 5b is fed in the first exhaust port 1b2 (in the direction of an arrow F) and discharged through the suction pipe 1b5 (refer to FIG. 2b), and the resin flakes 5a drop from the second exhaust port 1b3 to the lower vessel 1b due to gravity to be recovered through the recovery port 1b4 (refer to FIG. 2b).

The resin flakes 5a recovered are pelletized in the successive palletizing step and used as a recycled resin.

With respect to classification conditions of the physical field application device as shown in this figure, the flake supply amount, the amount of air suctioned from the suction pipe 1b5 (refer to FIG. 2b), the amount of air suctioned from the recovery port 1b4 (refer to FIG. 2b), the amount of air flowing in the housing 2″ (in the direction of an arrow B2) from the air introduction port 1d (the amount of air exhausted from the opening 2″e), the amount of air flowing in the direction of the space 4″ (in the direction of an arrow B1), and the temperature are the same as those denoted above in the physical field application device as shown in FIG. 4a.

The amount of suction air is a value obtained according to the same method as denoted in the physical field application device as shown in FIG. 4a. Each of the air velocity and temperature is a value measured according to the same method as denoted in the physical field application device as shown in FIG. 4a.

In this classifying apparatus, the magnetic field to be applied is preferably from 0.05 to 10 T (Tesla), and more preferably from 0.5 to 10 T (Tesla), in view of classification efficiency.

The applied magnetic field (magnetic flux density) can be measured by means of a Tesla Meter TM 701 produced by Sato Shoji Co., Ltd.

A waste resin applied in the manufacturing process of the recycled resin in the invention is not specifically limited, and examples thereof include ordinary thermoplastic resins, and a polyester based resin is preferred as the waste resin.

### (Polyester Based Resin)

Although the polyester based resin is not specifically limited, it is preferably a polyester resin composed mainly of a dicarboxylic acid component and a diol component.

Examples of the dicarboxylic acid component as the main component include terephthalic acid, isophthalic acid, phthalic acid, 2,6-naphthalene dicarboxylic acid, 2,7-naphthalene dicarboxylic acid, diphenyl sulfone dicarboxylic acid, diphenyl ether dicarboxylic acid, diphenylethane dicarboxylic acid, cyclohexane dicarboxylic acid, diphenyl dicarboxylic acid, diphenyl thioether dicarboxylic acid, diphenyl ketone dicarboxylic acid, and phenyl indane dicarboxylic acid. Examples of the diol component include ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydroxyphenyl)sulfone, bisphenolfluorene dihydroxyethyl ether, diethylene glycol, neopentyl glycol, hydroquinone and cyclohexane diol.

Among the polyester resins having the above-described components as the main component, polyester resins containing terephthalic acid and/or 2,6-naphthalene dicarboxylic acid as the dicarboxylic acid and ethylene glycol and/or 1,4-cyclohexane dimethanol as the diol component are preferred. A polyester resin containing polyethylene terephthalate or polyethylene 2,6-naphthalate as the main component, a copolyester comprised of terephthalic acid, 2,6-naphthalene dicarboxylic acid and ethylene glycol and a mixture of two or more kinds thereof are more preferred.

In a recycled resin manufacturing method in which resin flakes obtained by sorting molded waste resin products and pulverizing the sorted molded waste resin products are subjected to a resin recycling process comprising at least a washing step, a drying step, a classifying step and a pelletizing step to obtain a recycled resin, a recycled resin having an oligomer content of not more than 1% by mass is obtained employing, at the classifying step, a classifying apparatus comprising a physical field application device employing a combination of an airflow force and another physical field other than the airflow force. Such a resin has the following advantages.

1. Hydrolysis of the resin is restrained by reduction of the content in the resin of an oligomer, which has a high moisture absorption property and which is difficult to release moisture.

2. The restraint of the hydrolysis reduces a content in the resin of lower molecular weight compounds including an oligomer, resulting in prevention of deterioration of physical properties of the recycled resin.

3. The resulting recycled resin can be reused in the same applications as a virgin resin.

### EXAMPLES

Next, the present invention will be explained referring to examples, but the invention is not specifically limited thereto.

### Example 1

A recycled resin was manufactured from a waste resin according to the flow diagram as shown in FIG. 1.

### (Preparation of Waste Resin)

As a waste resin, 1000 kg of a PET bottle available on the market were prepared.

### (Preparation of Classifying Apparatus)

As classifying apparatuses were prepared a classifying apparatus No. 1A as shown in FIG. 2a or 2b employing a physical field application device as shown in FIG. 3 having, as a physical field, a combination of an airflow force field and another physical field other than the airflow force field, a classifying apparatus No. 1B as shown in FIG. 2a or 2b employing a physical field application device as shown in FIG. 4a having, as a physical field, a combination of an airflow force field and an electric field, and a classifying apparatus No. 1C as shown in FIG. 2a or 2b employing a physical field application device as shown in FIG. 4b having, as a physical field, a combination of an airflow force field and a magnetic field. The constitution of the classifying apparatus Nos. 1A to 1C is shown in Table 1. In each of the classifying apparatus Nos. 1A to 1C prepared above, the height of the classifying section was 50 mm, and the height of the space from the top of the lower vessel to the bottom of the physical field application device was 10 mm (20% of the height of the classifying section).

TABLE 1

| Classifying | |
|---|---|
| Apparatus No. | Classification Process |
| 1A | Combination of Airflow Force and Physical field |
| | (Force Field) other than Airflow Force |
| 1B | Combination of Airflow Force and Electric Field |
| 1C | Combination of Airflow Force and Magnetic Field |

(Manufacture of recycled resin)

The PET bottles of 1000 kg prepared above were decapped in the sorting step, and subjected to pulverization in the pulverizing step to obtain flakes with an average size of 20 mm (with a standard deviation of 0.2). Subsequently, the resulting flakes were washed in a 60° C. hot water for 10 minutes in the washing step while stirring to remove contaminants or deposited foreign matter, then subjected to separation in the separating step to remove different kinds of resins coexisting therein according to a sedimentation method employing the difference in the specific gravities, and air dried at 90° C. for one minute. Employing each of the classifying apparatus Nos. 1A to 1C prepared above, the resulting dried flakes were classified in the classifying step under the conditions described later. The moisture content of the flakes after classified was 0.8% by mass.

Herein, the moisture content of the flakes refers to one measured according to a Karl Fischer's method, employing a Hiranuma trace moisture measuring device produced by Hitachi High-Technologies Corporation.

The flakes after classified were pelletized in the palletizing step through a pelletizer to prepare pelletized resins. Thus, recycled resins having a different oligomer content were manufactured to obtain Sample Nos. 101 through 115 as shown in Table 2. The oligomer content of the PET bottle as a waste resin was 0.01% by mass.

The oligomer content of the recycled resins was varied by changing the intensity of the force field applied in each of the classifying apparatus Nos. 1A to 1C. Herein, the oligomer refers to a low molecular weight polymeric compound having a number average molecular weight of from 100 to 1,500, the number average molecular weight measured according to the method described previously in this document.

The pelletization was carried out employing a twin-screw extruder KTX 30 (with two vacuum vents) produced by Kobe Steel, Ltd.

Classifying apparatus No. 1A

| | | |
|---|---|---|
| Amount to be classified: | 100 | kg |
| Flake supply amount: | 10 | kg/hour |
| Classification time: | 600 | minutes |
| Amount of air suctioned from the suction pipe 1b5 | 15 | m³/minute |
| (refer to FIG. 2b) | | |
| Amount of air suctioned from the recovery port 1b4 | 5 | m³/minute |
| (refer to FIG. 2b) | | |
| Amount of air from a resin sample (resin flakes) | 10 | m³/minute |
| supply port 1a2 (refer to FIG. 2b) | | |
| Amount of air flowing from the air introduction | 18 | m³/minute |
| port 1d (refer to FIG. 3) towards the inside of | | |
| the housing 2 (in the direction as shown in an | | |
| arrow B2) (refer to FIG. 3) | | |
| Amount of air flowing in the space 4 (refer to | 2 | m³/minute |
| FIG. 3) (in the direction as shown in an arrow B1) | | |

The amount of the suctioned air is represented by a value obtained by multiplying air velocity by the cross-section area of a pipe in which air flows. The airflow velocity is a value measured through an Anemomaster Air Velocity Meter Model 6141 produced by Nippon Kanomax Co., Ltd. Temperature 25° C.

The temperature was measured through a bar temperature sensor produced by Keyence Co., Ltd.

The force field other than the airflow force field was adjusted by changing the number of shielding plates provided.

The shielding plates were provided at an angle of 45° to the ceiling plate of the housing so as to face the center of the housing.

Classifying apparatus No. 1B

| | | |
|---|---|---|
| Amount to be classified: | 100 | kg |
| Flake supply amount: | 10 | kg/hour |
| Classification time: | 600 | minutes |
| Amount of air suctioned from the suction pipe 1b5 | 15 | m³/minute |
| (refer to FIG. 2b) | | |
| Amount of air suctioned from the recovery port 1b4 | 5 | m³/minute |
| (refer to FIG. 2b) | | |
| Amount of air from a resin sample (resin flakes) | 10 | m³/minute |
| supply port 1a2 (refer to FIG. 2b) | | |
| Amount of air flowing from the air introduction | 18 | m³/minute |
| port 1d (refer to FIG. 4a) towards the inside of | | |
| the housing 2′ (in the direction as shown in | | |
| an arrow B2) (refer to FIG. 4a) | | |
| Amount of air flowing in the space 4′ (refer | 2 | m³/minute |
| to FIG. 4a) (in the direction as shown in an | | |
| arrow B1) | | |

The amount of the suctioned air is represented by a value obtained by multiplying air velocity by the cross-section area of a pipe in which air flows. The airflow velocity is a value measured through an Anemomaster Air Velocity Meter Model 6141 produced by Nippon Kanomax Co., Ltd. Temperature 25° C.

The temperature was measured through a bar temperature sensor produced by Keyence Co., Ltd.

The electric field applied was measured through an YX-361TR produced by Sanwa Denki Keiki Co., Ltd.

Classifying apparatus No. 1C

| | | |
|---|---|---|
| Amount to be classified: | 100 | kg |
| Flake supply amount: | 10 | kg/hour |
| Classification time: | 600 | minutes |
| Amount of air suctioned from the suction pipe 1b5 | 15 | m³/minute |
| (refer to FIG. 2b) | | |
| Amount of air suctioned from the recovery port 1b4 | 5 | m³/minute |
| (refer to FIG. 2b) | | |
| Amount of air from a resin sample (resin flakes) | 10 | m³/minute |
| supply port 1a2 (refer to FIG. 2b) | | |
| Amount of air flowing from the air introduction | 18 | m³/minute |
| port 1d (refer to FIG. 4b) towards the inside of | | |
| the housing 2″ (in the direction as shown | | |
| in an arrow B2) (refer to FIG. 4b) | | |
| Amount of air flowing in the space 4″ (refer | 2 | m³/minute |
| to FIG. 4b) (in the direction as shown in an | | |
| arrow B1) | | |

The amount of the suctioned air is represented by a value obtained by multiplying air velocity by the cross-section area of a pipe in which air flows. The airflow velocity is a value measured through an Anemomaster Air Velocity Meter Model 6141 produced by Nippon Kanomax Co., Ltd. Temperature 25° C.

The temperature was measured through a bar temperature sensor produced by Keyence Co., Ltd.

The magnetic field applied was measured through a Tesla Meter TM701 produced by Sato Shoji Co., Ltd.

TABLE 2

| | | | Force Field | | Magnetic |
|---|---|---|---|---|---|
| | | Oligomer | (Number of | | Field |
| Sam- | Classifying | Content | Shielding | Electric | (Magnetic Flux |
| ple | Apparatus | (% by | Plates) | Field | Density) |
| No. | No. | mass) | (a*/b*) | (V/mm) | (T) |
| 101 | 1A | 1.1 | 2/3 | — | — |
| 102 | 1A | 1.0 | 2/5 | — | — |
| 103 | 1A | 0.5 | 2/7 | — | — |
| 104 | 1A | 0.1 | 2/9 | — | — |
| 105 | 1A | 0.05 | 2/10 | — | — |
| 106 | 1B | 1.1 | — | 5 | — |
| 107 | 1B | 1.0 | — | 10 | — |
| 108 | 1B | 0.5 | — | 20 | — |
| 109 | 1B | 0.1 | — | 40 | — |
| 110 | 1B | 0.05 | — | 50 | — |
| 111 | 1C | 1.1 | — | — | 0.05 |
| 112 | 1C | 1.0 | — | — | 1.00 |
| 113 | 1C | 0.5 | — | — | 3.00 |
| 114 | 1C | 0.1 | — | — | 7.00 |
| 115 | 1C | 0.05 | — | — | 9.00 |

a*Number of first shielding plates,
b*Number of second shielding plates,

### Evaluation

Each of Samples Nos. 101 through 115 obtained above was subjected to Izod impact strength tests, the Izod impact strength measured according to the following method, and evaluated according to the following criteria. The results are shown in Table 3.

### Measurement Method of Izod Impact Strength

Each of the pelletized resins prepared above, after dried at 100° C. for 4 hours, was molded at a prescribed cylinder temperature of 280° C. and at a mold temperature of 40° C. in an injection molding machine J55ELII (produced by Nippon Seikosho Co., Ltd) to prepare a strip-type specimen with a size of 100 mm×10 mm×4 mm. The resulting specimen was subjected to Izod impact strength tests (U notch, R=1 mm) according to JIS-K7111. The Izod impact strength of virgin PET was 70 J/m.

### Evaluation of Izod Impact Strength

A: The Izod impact strength is from 60 J/m to less than 80 J/m (excellent)
B: The Izod impact strength was from 40 J/m to less than 60 J/m (good).
C: The Izod impact strength was from 30 J/m to less than 40 J/m (practically non-problematic).
D: The Izod impact strength was less than 30 J/m (practically problematic).

TABLE 3

| Sample | Classifying | Oligomer Content | Izod Impact | |
|---|---|---|---|---|
| No. | Apparatus No. | (% by mass) | Strength | Remarks |
| 101 | 1A | 1.1 | D | Comparative |
| 102 | 1A | 1.0 | C | Inventive |
| 103 | 1A | 0.5 | B | Inventive |
| 104 | 1A | 0.1 | B | Inventive |
| 105 | 1A | 0.05 | A | Inventive |
| 106 | 1B | 1.1 | D | Comparative |
| 107 | 1B | 1.0 | C | Inventive |
| 108 | 1B | 0.5 | B | Inventive |
| 109 | 1B | 0.1 | B | Inventive |
| 110 | 1B | 0.05 | A | Inventive |
| 111 | 1C | 1.1 | D | Comparative |
| 112 | 1C | 1.0 | C | Inventive |
| 113 | 1C | 0.5 | B | Inventive |
| 114 | 1C | 0.1 | B | Inventive |
| 115 | 1C | 0.05 | A | Inventive |

It has been confirmed that recycled resins (Sample Nos. 102 through 105, 107 through 111 and 112 through 115) exhibit an Izod impact strength close to that of virgin PET, which were manufactured employing a classifying apparatus as shown in FIG. 2a, 2b, 3, 4a or 4b comprising a physical field application device having a combination of an airflow force and another physical field other than the airflow force to have an oligomer content of not more than 1% by mass, and provide superior results. Further, it has been confirmed that recycled resins (Sample Nos. 101, 106 and 111) having an oligomer content exceeding 1% by mass exhibit inferior Izod impact strength. Thus, superiority of the invention has been proved.

### Example 2

Recycled resins, Sample Nos. 201 through 205 were prepared in the same manner as Sample No. 102 of Example 1 above, except that a moisture content of the flakes after classified was changed as shown in Table 4. Herein, the moisture content of the flakes was changed by controlling the drying temperature. The moisture content was measured in the same manner as in Example 1.

### Evaluation

Each of the resulting Samples Nos. 201 through 205 was subjected to Izod impact strength tests in the same manner as in Example 1, and evaluated in the same manner as in Example 1. The results are shown in Table 4.

TABLE 4

| | Moisture Content of Flakes | Izod Impact | |
|---|---|---|---|
| Sample No. | (% by mass) | Strength | Remarks |
| 201 | 1.3 | C | Inventive |
| 202 | 1.0 | B | Inventive |
| 203 | 0.7 | B | Inventive |
| 204 | 0.4 | A | Inventive |
| 205 | 0.1 | A | Inventive |

It has been confirmed that Sample Nos. 202 through 505 exhibit an Izod impact strength close to that of virgin PET and provide excellent results which were manufactured so that the flakes after classified had a moisture content of not more than 1% by mass. Sample No. 201 exhibits a slightly inferior Izod impact strength which was manufactured so that the flakes after classified had a moisture content of 1.3% by mass, although practically non-problematic. Thus, superiority of the invention has been proved.

### Example 3

A recycled resin was manufactured from a waste resin according to the flow diagram as shown in FIG. 1.

### (Preparation of Waste Resin)

As a waste resin, 1000 kg of the same PET bottle available on the market as in Example 1 were prepared.

### (Preparation of Classifying Apparatus)

As classifying apparatuses, classifying apparatus Nos. 3A through 3E were prepared in the same manner as the classifying apparatus No. 1B in Example 1, except that the height h of the space from the top of the lower vessel to the bottom of the physical field application device was changed as shown in Table 5. Herein, the height H of the classifying section was 50 mm. The height h of the space from the top of the lower vessel to the bottom of the physical field application device and the ratio (%) of the height h to the height H of the classifying section are also shown in Table 5.

A classifying apparatus No. 3F (Comparative) was prepared which was of the same type as the classifying apparatus No. 1B in Example 1 except that the physical field application device was not provided.

TABLE 5

| Classifying | Height h | |
|---|---|---|
| Apparatus No. | (Ratio % of Height h to Height H) | |
| 3A | 4 | mm (8) |
| 3B | 5 | mm (10) |
| 3C | 15 | mm (30) |
| 3D | 25 | mm (50) |
| 3E | 30 | mm (60) |

| | |
|---|---|
| 3F | — |

Height h: a height of the space from the top of the lower vessel to the bottom of the physical field application device
Height H: a height of the classifying section.

### (Manufacture of Recycled Resin)

The PET bottles of 1000 kg prepared above were decapped in the sorting step, and subjected to pulverization in the pulverizing step to obtain resin flakes with a size as shown in Table 6. Thus, pulverized resin flakes Nos. 3-1 through 3-5 were obtained. Subsequently, the resulting resin flakes were washed in a 60° C. hot water for 10 minutes in the washing step while stirring to remove contaminants or deposited foreign matter, then subjected to separation in the separating step to remove different kinds of resins coexisting therein according to a sedimentation method employing the difference in the specific gravities, and air dried at 90° C. for one minute. Employing each of the classifying apparatus Nos. 3A to 3F prepared above, the resulting dried resin flakes were classified in the classifying step under the conditions as shown in Table 7, provided that the amount of the flakes to be classified was 100 kg and the flake supply amount was 50 kg/hour. The moisture content of the flakes after classified was 0.8% by mass. The moisture content was measured according to the same method as in Example 1.

The amount of the suctioned air is represented by a value obtained by multiplying air velocity by the cross-section area of a pipe in which air flows. The airflow velocity were measured through an Anemomaster Air Velocity Meter Model 6141 produced by Nippon Kanomax Co., Ltd.

The flakes after classified were pelletized in the palletizing step through a pelletizer. Thus, recycled resins were manufactured to obtain sample Nos. 301 through 336 as shown in Table 8. The oligomer content of the PET bottle as a waste resin was 0.01% by mass.

The pelletization was carried out employing a twin-screw extruder KTX 30 (with two vacuum vents) produced by Kobe Steel, Ltd.

TABLE 6

| Pulverized Resin | Size | Standard |
|---|---|---|
| Flakes No. | (mm) | Deviation |
| 3-1 | 4 | 0.3 |
| 3-2 | 5 | 0.4 |
| 3-3 | 10 | 0.4 |
| 3-4 | 30 | 0.6 |
| 3-5 | 40 | 0.8 |

TABLE 7

| | | Pulverized | Amount of Air | Amount of Air | | | | | |
|---|---|---|---|---|---|---|---|---|---|
| | Classifying | Resin | suctioned from | suctioned from | *Air | **Air | Electric | | Classification |
| Sample | Apparatus | Flakes | Suction Pipe | Recovery Port | Amount 1 | Amount 2 | Field | Temperature | Time |
| No. | No. | Nos. | (m³/min) | (m³/min) | (m³/min) | (m³/min) | (V/mm) | (° C.) | (minute) |
| 301 | 3A | 3-1 | 15 | 5 | 19.2 | 0.8 | 1 | 25 | 180 |
| 302 | 3A | 3-2 | 15 | 5 | 19.2 | 0.8 | 20 | 25 | 180 |
| 303 | 3A | 3-3 | 20 | 5 | 17.2 | 2.8 | 30 | 25 | 180 |
| 304 | 3A | 3-4 | 20 | 5 | 17.2 | 2.8 | 50 | 25 | 180 |
| 305 | 3A | 3-5 | 20 | 5 | 19.2 | 5.8 | 1000 | 25 | 180 |
| 306 | 3A | 3-3 | 20 | 5 | 17.2 | 2.8 | 30 | −5 | 180 |
| 307 | 3A | 3-3 | 20 | 5 | 17.2 | 2.8 | 30 | 0 | 180 |
| 308 | 3A | 3-3 | 20 | 5 | 17.2 | 2.8 | 30 | 10 | 180 |
| 309 | 3A | 3-3 | 20 | 5 | 17.2 | 2.8 | 30 | 40 | 180 |
| 310 | 3A | 3-3 | 20 | 5 | 17.2 | 2.8 | 30 | 60 | 180 |
| 311 | 3A | 3-3 | 20 | 5 | 17.2 | 2.8 | 30 | 70 | 180 |
| 312 | 3B | 3-1 | 15 | 5 | 19.2 | 1.0 | 1 | 25 | 180 |
| 313 | 3B | 3-2 | 15 | 5 | 19.2 | 1.0 | 20 | 25 | 180 |
| 314 | 3B | 3-3 | 20 | 5 | 17.2 | 2.8 | 30 | 25 | 180 |
| 315 | 3B | 3-4 | 15 | 5 | 19.2 | 1.0 | 50 | 25 | 180 |
| 316 | 3B | 3-5 | 15 | 5 | 19.2 | 1.0 | 100 | 25 | 180 |
| 317 | 3C | 3-1 | 15 | 5 | 17.2 | 3.0 | 20 | 25 | 180 |
| 318 | 3C | 3-2 | 15 | 5 | 17.2 | 3.0 | 20 | 25 | 180 |
| 319 | 3C | 3-3 | 20 | 5 | 17.2 | 2.8 | 30 | 25 | 180 |
| 320 | 3C | 3-4 | 15 | 5 | 17.2 | 3.0 | 50 | 25 | 180 |
| 321 | 3C | 3-5 | 15 | 5 | 17.2 | 3.0 | 100 | 25 | 180 |
| 322 | 3D | 3-1 | 15 | 5 | 15.0 | 5.0 | 20 | 25 | 180 |
| 323 | 3D | 3-2 | 15 | 5 | 15.0 | 5.0 | 20 | 25 | 180 |
| 324 | 3D | 3-3 | 20 | 5 | 17.2 | 2.8 | 30 | 25 | 180 |
| 325 | 3D | 3-4 | 15 | 5 | 15.0 | 5.0 | 50 | 25 | 180 |
| 326 | 3D | 3-5 | 15 | 5 | 15.0 | 5.0 | 100 | 25 | 180 |
| 327 | 3E | 3-1 | 15 | 5 | 15.0 | 5.0 | 20 | 25 | 180 |
| 328 | 3E | 3-2 | 15 | 5 | 15.0 | 5.0 | 20 | 25 | 180 |
| 329 | 3E | 3-3 | 20 | 5 | 17.2 | 2.8 | 30 | 25 | 180 |
| 330 | 3E | 3-4 | 15 | 5 | 15.0 | 5.0 | 50 | 25 | 180 |
| 331 | 3E | 3-5 | 15 | 5 | 15.0 | 5.0 | 100 | 25 | 180 |
| 332 | 3F | 3-1 | 15 | 5 | 20.0 | — | — | 25 | 180 |
| 333 | 3F | 3-2 | 15 | 5 | 20.0 | — | — | 25 | 180 |
| 334 | 3F | 3-3 | 20 | 5 | 25.0 | — | — | 25 | 180 |
| 335 | 3F | 3-4 | 15 | 5 | 20.0 | — | — | 25 | 180 |
| 336 | 3F | 3-5 | 15 | 5 | 20.0 | — | — | 25 | 180 |

*Air Amount 1: Amount of air flowing from the air introduction port 1d (refer to FIG. 4a) towards the inside of the housing 2′ (in the direction as shown in an arrow B2) (refer to FIG. 4a)
**Air Amount 2: Amount of air flowing in the space 4′ (refer to FIG. 4a) (in the direction as shown in an arrow B1)

### Evaluation

The oligomer content of each of Sample Nos. 301 through 336 was measured in the same manner as in Example 1 above, and evaluation was carried out in the same manner as in Example 1. The results are shown in Table 8.

TABLE 8

| | | Pulverized | Oligomer | |
|---|---|---|---|---|
| Sample | Classifying | Resin flakes | Content | |
| No. | Apparatus No. | Nos. | (% by mass) | Remarks |
| 301 | 3A | 3-1 | 0.01 | Inventive |
| 302 | 3A | 3-2 | 0.02 | Inventive |
| 303 | 3A | 3-3 | 0.04 | Inventive |
| 304 | 3A | 3-4 | 0.03 | Inventive |
| 305 | 3A | 3-5 | 0.04 | Inventive |
| 306 | 3A | 3-3 | 0.03 | Inventive |
| 307 | 3A | 3-3 | 0.02 | Inventive |
| 308 | 3A | 3-3 | 0.01 | Inventive |
| 309 | 3A | 3-3 | 0.05 | Inventive |
| 310 | 3A | 3-3 | 0.03 | Inventive |
| 311 | 3A | 3-3 | 0.08 | Inventive |
| 312 | 3B | 3-1 | 0.02 | Inventive |
| 313 | 3B | 3-2 | 0.03 | Inventive |
| 314 | 3B | 3-3 | 0.04 | Inventive |
| 315 | 3B | 3-4 | 0.04 | Inventive |
| 316 | 3B | 3-5 | 0.05 | Inventive |
| 317 | 3C | 3-1 | 0.02 | Inventive |
| 318 | 3C | 3-2 | 0.03 | Inventive |
| 319 | 3C | 3-3 | 0.05 | Inventive |
| 320 | 3C | 3-4 | 0.02 | Inventive |
| 321 | 3C | 3-5 | 0.03 | Inventive |
| 322 | 3D | 3-1 | 0.07 | Inventive |
| 323 | 3D | 3-2 | 0.05 | Inventive |
| 324 | 3D | 3-3 | 0.03 | Inventive |
| 325 | 3D | 3-4 | 0.02 | Inventive |
| 326 | 3D | 3-5 | 0.01 | Inventive |
| 327 | 3E | 3-1 | 0.04 | Inventive |
| 328 | 3E | 3-2 | 0.03 | Inventive |
| 329 | 3E | 3-3 | 0.02 | Inventive |
| 330 | 3E | 3-4 | 0.05 | Inventive |
| 331 | 3E | 3-5 | 0.07 | Inventive |
| 332 | 3F | 3-1 | 1.0 | Comparative |
| 333 | 3F | 3-2 | 1.0 | Comparative |
| 334 | 3F | 3-3 | 1.0 | Comparative |
| 335 | 3F | 3-4 | 1.1 | Comparative |
| 336 | 3F | 3-5 | 1.2 | Comparative |

It has been confirmed that recycled resins Sample Nos. 301 through 331 have an oligomer content of not more than 1% by mass, which were manufactured under classification conditions changed according to the size of the resin flakes, employing a classifying apparatus comprising a physical field application device using a combination of an airflow force and another physical field (force field) other than the airflow force. Further, it has been confirmed that recycled resins Sample Nos. 332 through 336 have an oligomer content exceeding 1% by mass, which were manufactured employing a classifying apparatus comprising a physical field application device which uses an airflow force but does not use another physical field other than the airflow force. Thus, the advantageous results of the invention have been proved.

### Example 4

A recycled resin was manufactured from a waste resin according to the flow diagram as shown in FIG. 1.

### (Preparation of Waste Resin)

As a waste resin, 1000 kg of the same PET bottle available on the market as in Example 1 were prepared.

### (Preparation of Classifying Apparatus)

The classifying apparatus Nos. 4A through 4E as shown in Table 9 were prepared in the same manner as the classifying apparatus No. 1A in Example 1 comprising a physical field application device having the shielding plates, except that the height h of the space between the top of the lower vessel of the classifying apparatus and the bottom of the physical field application device was changed as shown in Table 9. Herein, the height H of the classifying section was 50 mm. The height h of the space between the top of the lower vessel to the bottom of the physical field application device and the ratio (%) of the height h to the height H (of the classifying section) are also shown in Table 9.

A classifying apparatus No. 4F (Comparative) was prepared in the same manner as the classifying apparatus No. 1A in Example 1 except that the physical field application device having the shielding plates was not provided. Further, a classifying apparatus No. 4G (Comparative) was prepared in the same manner as the classifying apparatus No. 1A in Example 1 except that the physical field application device having the shielding plates was not provided but the same first and second shielding plates as used in the classifying apparatus No. 1A in Example 1 were provided at the same position as the first and second shielding plates in the classifying apparatus No. 1A in Example 1.

TABLE 9

| Classifying | Height h | |
|---|---|---|
| Apparatus No. | (Ratio % of Height h to Height H) | |
| 4A | 4 | mm (8) |
| 4B | 5 | mm (10) |
| 4C | 15 | mm (30) |
| 4D | 25 | mm (50) |
| 4E | 30 | mm (60) |

| | |
|---|---|
| 4F | — |
| 4G | — |

Height h: a height of the space from the top of the lower vessel to the bottom of the physical field application device
Height H: a height of the classifying section.

### (Manufacture of Recycled Resin)

The PET bottles of 1000 kg prepared above were decapped in the sorting step, and subjected to pulverization in the pulverizing step to obtain flakes with a size as shown in Table 10. Thus, pulverized resin flakes Nos. 4-1 through 4-5 were obtained. Subsequently, the resulting resin flakes were washed in a 60° C. hot water for 10 minutes while stirring in the washing step to remove contaminants or attached matter, then subjected to separation in the separating step to remove different kinds of resins coexisting therein according to a sedimentation method employing the difference in the specific gravities, and air dried at 90° C. for one minute. Employing each of the classifying apparatus Nos. 4A to 4G prepared above, the resulting dried resin flakes were classified in the classifying step under the conditions as shown in Table 11, provided that the amount of the flakes to be classified was 100 kg and the flake supply amount was 50 kg/hour. The classification time was 180 minutes. The moisture content of the flakes after classified was 0.8% by mass. The moisture content was measured according to the same method as in Example 1.

The amount of suction air is represented by a value obtained by multiplying air velocity by the cross-section area of a pipe in which air flows. The airflow velocity were measured through an Anemomaster Air Velocity Meter Model 6141 produced by Nippon Kanomax Co., Ltd.

The flakes after classified were pelletized in the palletizing step through a pelletizer. Thus, recycled resins were manufactured to obtain Sample Nos. 401 through 441 as shown in Table 10. The oligomer content of the PET bottle as a waste resin was 0.01% by mass. The oligomer content of each sample was measured in the same manner as in Example 1 above.

The pelletization was carried out employing a twin-screw extruder KTX 30 (with two vacuum vents) produced by Kobe Steel, Ltd.

TABLE 10

| Pulverized Resin | Size | Standard |
|---|---|---|
| Flakes No. | (mm) | Deviation |
| 4-1 | 4 | 0.3 |
| 4-2 | 5 | 0.4 |
| 4-3 | 10 | 0.4 |
| 4-4 | 30 | 0.6 |
| 4-5 | 40 | 0.8 |

TABLE 11

| | | Pulverized | Amount of Air | Amount of Air | | | Force Field | |
|---|---|---|---|---|---|---|---|---|
| | Classifying | Resin | suctioned from | suctioned from | *Air | **Air | (Number of | |
| Sample | Apparatus | Flakes | Suction Pipe | Recovery Port | Amount 1 | Amount 2 | Shielding | Temperature |
| No. | No. | Nos. | (m³/min) | (m³/min) | (m³/min) | (m³/min) | Plates) (a*/b*) | (° C.) |
| 401 | 4A | 4-1 | 15 | 5 | 19.2 | 0.8 | 1/2 | 25 |
| 402 | 4A | 4-2 | 15 | 5 | 19.2 | 0.8 | 2/3 | 25 |
| 403 | 4A | 4-3 | 20 | 5 | 17.2 | 2.8 | 3/6 | 25 |
| 404 | 4A | 4-4 | 20 | 5 | 17.2 | 2.8 | 3/8 | 25 |
| 405 | 4A | 4-5 | 20 | 5 | 19.2 | 5.8 | 4/10 | 25 |
| 406 | 4A | 4-3 | 20 | 5 | 17.2 | 2.8 | 3/6 | −5 |
| 407 | 4A | 4-3 | 20 | 5 | 17.2 | 2.8 | 3/6 | 0 |
| 408 | 4A | 4-3 | 20 | 5 | 17.2 | 2.8 | 3/6 | 10 |
| 409 | 4A | 4-3 | 20 | 5 | 17.2 | 2.8 | 3/6 | 40 |
| 410 | 4A | 4-3 | 20 | 5 | 17.2 | 2.8 | 3/6 | 60 |
| 411 | 4A | 4-3 | 20 | 5 | 17.2 | 2.8 | 3/6 | 70 |
| 412 | 4B | 4-1 | 15 | 5 | 19.2 | 1.0 | 1/2 | 25 |
| 413 | 4B | 4-2 | 15 | 5 | 19.2 | 1.0 | 2/3 | 25 |
| 414 | 4B | 4-3 | 20 | 5 | 17.2 | 2.8 | 3/6 | 25 |
| 415 | 4B | 4-4 | 15 | 5 | 19.2 | 1.0 | 3/8 | 25 |
| 416 | 4B | 4-5 | 15 | 5 | 19.2 | 1.0 | 4/10 | 25 |
| 417 | 4C | 4-1 | 15 | 5 | 17.2 | 3.0 | 1/2 | 25 |
| 418 | 4C | 4-2 | 15 | 5 | 17.2 | 3.0 | 2/3 | 25 |
| 419 | 4C | 4-3 | 20 | 5 | 17.2 | 2.8 | 3/6 | 25 |
| 420 | 4C | 4-4 | 15 | 5 | 17.2 | 3.0 | 3/8 | 25 |
| 421 | 4C | 4-5 | 15 | 5 | 17.2 | 3.0 | 4/10 | 25 |
| 422 | 4D | 4-1 | 15 | 5 | 15.0 | 5.0 | 1/2 | 25 |
| 423 | 4D | 4-2 | 15 | 5 | 15.0 | 5.0 | 2/3 | 25 |
| 424 | 4D | 4-3 | 20 | 5 | 17.2 | 2.8 | 3/6 | 25 |
| 425 | 4D | 4-4 | 15 | 5 | 15.0 | 5.0 | 3/8 | 25 |
| 426 | 4D | 4-5 | 15 | 5 | 15.0 | 5.0 | 4/10 | 25 |
| 427 | 4E | 4-1 | 15 | 5 | 15.0 | 5.0 | 1/2 | 25 |
| 428 | 4E | 4-2 | 15 | 5 | 15.0 | 5.0 | 2/3 | 25 |
| 429 | 4E | 4-3 | 20 | 5 | 17.2 | 2.8 | 3/6 | 25 |
| 430 | 4E | 4-4 | 15 | 5 | 15.0 | 5.0 | 3/8 | 25 |
| 431 | 4E | 4-5 | 15 | 5 | 15.0 | 5.0 | 4/10 | 25 |
| 432 | 4F | 4-1 | 15 | 5 | 20.0 | — | — | 25 |
| 433 | 4F | 4-2 | 15 | 5 | 20.0 | — | — | 25 |
| 434 | 4F | 4-3 | 20 | 5 | 25.0 | — | — | 25 |
| 435 | 4F | 4-4 | 15 | 5 | 20.0 | — | — | 25 |
| 436 | 4F | 4-5 | 15 | 5 | 20.0 | — | — | 25 |
| 437 | 4G | 4-1 | 15 | 5 | 20.0 | — | 1/2 | 25 |
| 438 | 4G | 4-2 | 15 | 5 | 20.0 | — | 2/3 | 25 |
| 439 | 4G | 4-3 | 20 | 5 | 25.0 | — | 3/6 | 25 |
| 440 | 4G | 4-4 | 15 | 5 | 20.0 | — | 3/8 | 25 |
| 441 | 4G | 4-5 | 15 | 5 | 20.0 | — | 4/10 | 25 |

*Air Amount 1: Amount of air flowing from the air introduction port 1d (refer to FIG. 3) towards the inside of the housing 2 (in the direction as shown in an arrow B2) (refer to FIG. 3);
**Air Amount 2: Amount of air flowing in the space 4 (refer to FIG. 3) (in the direction as shown in an arrow B1);
a*Number of first shielding plates;
b*Number of second shielding plates

### Evaluation

The oligomer content of each of Sample Nos. 401 through 441 was measured in the same manner as in Example 1 above, and evaluation was carried out in the same manner as in Example 1. The results are shown in Table 12.

TABLE 12

| | | Pulverized | Oligomer | |
|---|---|---|---|---|
| Sample | Classifying | Resin Flakes | Content | |
| No. | Apparatus No. | Nos. | (% by mass) | Remarks |
| 401 | 4A | 4-1 | 0.02 | Inventive |
| 402 | 4A | 4-2 | 0.02 | Inventive |
| 403 | 4A | 4-3 | 0.05 | Inventive |
| 404 | 4A | 4-4 | 0.06 | Inventive |
| 405 | 4A | 4-5 | 0.07 | Inventive |
| 406 | 4A | 4-3 | 0.03 | Inventive |
| 407 | 4A | 4-3 | 0.03 | Inventive |
| 408 | 4A | 4-3 | 0.02 | Inventive |
| 409 | 4A | 4-3 | 0.05 | Inventive |
| 410 | 4A | 4-3 | 0.03 | Inventive |
| 411 | 4A | 4-3 | 0.02 | Inventive |
| 412 | 4B | 4-1 | 0.02 | Inventive |
| 413 | 4B | 4-2 | 0.03 | Inventive |
| 414 | 4B | 4-3 | 0.04 | Inventive |
| 415 | 4B | 4-4 | 0.04 | Inventive |
| 416 | 4B | 4-5 | 0.05 | Inventive |
| 417 | 4C | 4-1 | 0.02 | Inventive |
| 418 | 4C | 4-2 | 0.03 | Inventive |
| 419 | 4C | 4-3 | 0.05 | Inventive |
| 420 | 4C | 4-4 | 0.02 | Inventive |
| 421 | 4C | 4-5 | 0.03 | Inventive |
| 422 | 4D | 4-1 | 0.07 | Inventive |
| 423 | 4D | 4-2 | 0.05 | Inventive |
| 424 | 4D | 4-3 | 0.03 | Inventive |
| 425 | 4D | 4-4 | 0.02 | Inventive |
| 426 | 4D | 4-5 | 0.02 | Inventive |
| 427 | 4E | 4-1 | 0.03 | Inventive |
| 428 | 4E | 4-2 | 0.03 | Inventive |
| 429 | 4E | 4-3 | 0.03 | Inventive |
| 430 | 4E | 4-4 | 0.04 | Inventive |
| 431 | 4E | 4-5 | 0.06 | Inventive |
| 432 | 4F | 4-1 | 1.30 | Comparative |
| 433 | 4F | 4-2 | 1.30 | Comparative |
| 434 | 4F | 4-3 | 1.40 | Comparative |
| 435 | 4F | 4-4 | 1.20 | Comparative |
| 436 | 4F | 4-5 | 1.30 | Comparative |
| 437 | 4G | 4-1 | 1.20 | Comparative |
| 438 | 4G | 4-2 | 1.20 | Comparative |
| 439 | 4G | 4-3 | 1.20 | Comparative |
| 440 | 4G | 4-4 | 1.20 | Comparative |
| 441 | 4G | 4-5 | 1.10 | Comparative |

It has been confirmed that recycled resins Sample Nos. 401 through 431 have an oligomer content of not more than 1% by mass which were manufactured under classification conditions changed according to the size of the resin flakes, employing the classifying apparatus using force of airflow and another physical field (force field) in combination. Further, it has been confirmed that recycled resins Sample Nos. 432 through 436 have an oligomer content exceeding 1% by mass, which were manufactured employing the classifying apparatus in which the physical field application device having the shielding plates was not provided. Still further, it has been confirmed that recycled resins Sample Nos. 437 through 441 have an oligomer content exceeding 1% by mass which were manufactured under classification conditions changed according to the size of the rein flakes, employing the classifying apparatus provided with a combination of airflow force and another physical field (force field) other than the airflow force in which the physical field application device having the shielding plates was not provided. Thus, superiority of the invention has been proved.

1. A manufacturing process of a recycled resin, the process comprising the steps of:
sorting a molded waste resin product;
pulverizing the sorted molded waste resin product into resin flakes;
washing the resin flakes,
separating the washed resin flakes to remove different kinds of resins;
drying the separated resin flakes;
classifying the dried resin flakes to remove foreign matter deposited on the flakes, the classifying being carried out employing a classifying apparatus comprising a classifying section and provided therein, a physical field application device having an airflow force field and another physical field other than the airflow force field; and
pelletizing the classified resin flakes,
wherein the recycled resin has an oligomer content of not more than 1% by mass.

2. The manufacturing process of the recycled resin of claim 1, the classifying section having an upper space and a lower space with a height of from 10 to 50% of a height of the classifying section, wherein the physical field application device is provided in the upper space of the classifying section.

3. The manufacturing process of the recycled resin of claim 1, wherein the another physical field, comprises a magnetic field and the physical field application device has therein a magnetic field application member for applying the magnetic field.

4. The manufacturing process of the recycled resin of claim 1, wherein the another physical field comprises an electric, field and the physical field application device has therein an electric field application member for applying the electric field.

5. The manufacturing process of the recycled resin of claim 1, wherein the another physical field comprises a force field and the physical field application device has therein a force field application member for applying the force field.

6. The manufacturing process of the recycled resin of claim 5, the force field application member being composed of a first shielding plate and a second shield plate, the dried resin flakes firstly colliding with the first shielding plate and then colliding with the second shielding plate, wherein when the number of the first shielding plate is n, the number of the first shielding plate is a n+k, in which n and k independently represent an integer of 1 or more.

7. The manufacturing process of the recycled resin of claim 1, wherein the molded waste resin product is composed of a polyester based resin.

8. The manufacturing process of the recycled resin of claim 1, wherein the classified resin flakes have a moisture content of not more than 1% by mass.

9. The manufacturing process of the recycled resin of claim 1, wherein the oligomer has a number average molecular weight of from 100 to 1500.

10. The manufacturing process of the recycled resin of claim 1, wherein the resin flakes have a size of from 5 to 30 mm.

11. The manufacturing process of the recycled resin of claim 10, wherein the resin flakes have an aspect ratio of from 1 to 10.
